(19) United States
(12) Patent Application Publication
(10) Pub. No.: US 2026/0127995 A1
(43) Pub. Date: May 7, 2026

(54) GATE DRIVING CIRCUITS AND DISPLAY PANELS

(71) Applicant: Guangzhou China Star Optoelectronics Semiconductor Display Technology Co., LTD., Guangzhou, Guangdong (CN)

(72) Inventor: Xiaohai CHEN, Guangzhou, Guangdong (CN)

(73) Assignee: Guangzhou China Star Optoelectronics Semiconductor Display Technology Co., LTD., Guangzhou, Guangdong (CN)

(21) Appl. No.: 18/687,880

(22) PCT Filed: Feb. 18, 2024
(86) PCT No.: PCT/CN2024/077383

§ 371 Date: Feb. 29, 2024

(30) Foreign Application Priority Data
Feb. 4, 2024 (CN) 202410161221.0

(51) Int. Cl. G09G 3/20

(52) U.S. Cl. CPC G09G 3/2092; G09G 2310/0267; G09G 2310/0294; G09G 2310/062; G09G 2330/045

(57) ABSTRACT

The present disclosure provides a gate driving circuit and a display panel. When a pull-up control module controls an electrical connection between a first voltage terminal and a second node, an inverting module disconnects an electrical connection between a low-frequency clock signal terminal and a third node in response to a potential of the second node, the inverting module controls an electrical connection between the first voltage terminal and the third node in response to a potential of a first node, and a pull-down holding module disconnects an electrical connection between the first voltage terminal and the first node in response to a potential of the third node.

### TECHNICAL FIELD

The present disclosure relates to the field of display technologies, and in particular, to gate driving circuits and display panels.

### BACKGROUND

In a gate driving circuit, in order to output a required gate control signal, two transistors are generally arranged to respectively pull up and pull down a potential of a first node, so that an output transistor can in the on or off state in response to the potential of the first node. However, during a process of the output transistor changing from the off state to the on state in response to the potential of the first node, the transistor configured to pull down the potential of the first node undergoes the process of changing from the on state to the off state. Therefore, when the transistor configured to pull up the potential of the first node is used to pull up the potential of the first node, the transistor configured to pull down the potential of the first node will still maintain the on state for a certain period of time, affecting the effect of pulling up the potential of the first node, causing the gate driving circuit to have problems with temperature rise and reduced reliability.

### SUMMARY

Embodiments of the present disclosure provide gate driving circuits and display panels, which may improve the problems of temperature rise and reduced reliability of the gate driving circuit.

Embodiments of the present disclosure provide a gate driving circuit, which includes an inverting module, a pull-down holding module, and a pull-up control module. The inverting module is electrically connected to a first voltage terminal, a first node, a second node, and a third node. The inverting module is configured to control a signal transmission between the first voltage terminal and the third node in response to a potential of the first node, and configured to control a signal transmission between a low-frequency clock signal terminal and the third node in response to a potential of the second node. The pull-down holding module is electrically connected to the first voltage terminal, the first node, and the third node. The pull-down holding module is configured to control a signal transmission between the first voltage terminal and the first node in response to a potential of the third node. The pull-up control module is electrically connected to the first voltage terminal, the first node, and the second node, configured to pull up the potential of the first node in response to a pull-up control signal. The pull-up control module is configured to control a signal transmission between the first voltage terminal and the second node in response to the pull-up control signal. When the pull-up control module is configured to electrically connect the first voltage terminal and the second node in response to the pull-up control signal, the inverting module is configured to disconnect an electrical connection between the low-frequency clock signal terminal and the third node in response to the potential of the second node, the inverting module is also configured to control an electrical connection between the first voltage terminal and the third node in response to the potential of the first node, and the pull-down holding module is configured to disconnect an electrical connection between the first voltage terminal and the first node in response to the potential of the third node.

The present disclosure also provides a display panel, including a gate driving unit. The gate driving unit includes a plurality of any of the above gate driving circuits, and the plurality of gate driving circuits are arranged in cascade. An (n−4)th stage gate control signal output by an (n−4)th stage gate driving circuit serves as the pull-up control signal received by the pull-up control module of the n-th stage gate driving circuit.

### DESCRIPTION OF DRAWINGS

FIG. 1 is a schematic block diagram f of a gate driving circuit provided by an embodiment of the present disclosure;

FIG. 2 is a schematic structural diagram of a gate driving circuit provided by an embodiment of the present disclosure;

FIG. 3 is a schematic structural diagram of another gate driving circuit provided by an embodiment of the present disclosure;

FIG. 4 is a timing diagram of a corresponding gate driving circuit provided by an embodiment of the present disclosure;

FIG. 5 is a simulation timing diagram before the improvement of a corresponding gate driving circuit provided by an embodiment of the present disclosure;

FIG. 6 is a simulation timing diagram after the improvement of a corresponding gate driving circuit provided by an embodiment of the present disclosure;

FIG. 7 is a schematic structural diagram of a display panel provided by an embodiment of the present disclosure;

FIG. 8 is a cascade relationship diagram of a plurality of gate driving circuits provided by an embodiment of the present disclosure;

FIG. 9 is a schematic diagram showing a corresponding relationship between gate driving circuits and high-frequency clock signals provided by an embodiment of the present disclosure;

FIG. 10 is a driving timing diagram of a display panel provided by an embodiment of the present disclosure.

### EMBODIMENTS OF THE INVENTION

In order to make the purposes, technical solutions, and effects of the present disclosure clearer, the present disclosure will be further described in detail below with reference to the accompanying drawings and examples. It should be understood that the specific embodiments described here are only used to explain the present disclosure and are not intended to limit the present disclosure.

Optionally, in some embodiments, the pull-up control module includes a first control unit and a second control unit. The first control unit includes a first transistor, a control terminal of the first transistor is configured to receive the pull-up control signal, an input terminal of the first transistor is electrically connected to the control terminal of the first transistor, and an output terminal of the first transistor is electrically connected to the first node. The second control unit includes a second transistor, a control terminal of the second transistor is configured to receive the pull-up control signal, an input terminal of the second transistor is electrically connected to the first voltage terminal, and an output terminal of the second transistor is electrically connected to the second node.

Optionally, in some embodiments, the inverting module includes a third transistor, a fourth transistor, a fifth transistor, and a sixth transistor. A control terminal of the third transistor electrically connected to the low-frequency clock signal terminal, an input terminal of the third transistor electrically connected to the control terminal of the third transistor, and an output terminal of the third transistor electrically connected to the second node. A control terminal of the fourth transistor electrically connected to the second node, an input terminal of the fourth transistor electrically connected to the low-frequency clock signal terminal, and an output terminal of the fourth transistor electrically connected to the third node. A control terminal of the fifth transistor electrically connected to the first node, an input terminal of the fifth transistor electrically connected to the first voltage terminal, and an output terminal of the fifth transistor electrically connected to the second node. A control terminal of the sixth transistor electrically connected to the first node, an input terminal of the sixth transistor electrically connected to the first voltage terminal, and an output terminal of the sixth transistor electrically connected to the third node.

Optionally, in some embodiments, the pull-down holding module includes a seventh transistor, a control terminal of the seventh transistor is electrically connected to the third node, an input terminal of the seventh transistor is electrically connected to the first voltage terminal, and an output terminal of the seventh transistor is electrically connected to the first node.

Optionally, in some embodiments, the pull-up control module further includes a third control unit, and the third control unit includes an eighth transistor. A control terminal of the eighth transistor is configured to receive the pull-up control signal, an input terminal of the eighth transistor is electrically connected to the first voltage terminal, and an output terminal of the eighth transistor is electrically connected to the third node.

Optionally, in some embodiments, the second node includes a first sub-node and a second sub-node, and the third node includes a third sub-node and a fourth sub-node. The low-frequency clock signal terminal includes a first low-frequency clock signal terminal and a second low-frequency clock signal terminal.

The inverting module includes a first inverting unit and a second inverting unit. In the first inverting unit, the output terminal of the third transistor, the control terminal of the fourth transistor, and the output terminal of the fifth transistor are electrically connected to the first sub-node, the output terminal of the fourth transistor and the output terminal of the sixth transistor are electrically connected to the third sub-node, and the control terminal of the third transistor and the input terminal of the fourth transistor are electrically connected to the first low-frequency clock signal terminal. In the second inverting unit, the output terminal of the third transistor, the control terminal of the fourth transistor, and the output terminal of the fifth transistor are electrically connected to the second sub-node, the output terminal of the fourth transistor and the output terminal of the sixth transistor are electrically connected to the fourth sub-node, and the control terminal of the third transistor and the input terminal of the fourth transistor are electrically connected to the second low-frequency clock signal terminal.

The pull-down holding module includes a first pull-down holding unit and a second pull-down holding unit, the control terminal of the seventh transistor of the first pull-down holding unit is electrically connected to the third sub-node, and the control terminal of the seventh transistor of the second pull-down holding unit is electrically connected to the fourth sub-node.

The second control unit of the pull-up control module includes a first control sub-unit and a second control sub-unit, the output terminal of the second transistor of the first control sub-unit is electrically connected to the first sub-node, and the output terminal of the second transistor of the second control sub-unit is electrically connected to the second sub-node.

The third control unit of the pull-up control module includes a third control sub-unit and a fourth control sub-unit, the output terminal of the eighth transistor of the third control sub-unit is electrically connected to the third sub-node, and the output terminal of the eighth transistor of the fourth control sub-unit is electrically connected to the fourth sub-node.

Optionally, in some embodiments, the pull-down holding module includes a ninth transistor, a control terminal of the ninth transistor is electrically connected to the third node, an input terminal of the ninth transistor is electrically connected to the first voltage terminal, and an output terminal of the ninth transistor is electrically connected to a signal output terminal of the gate driving circuit.

Optionally, in some embodiments, the gate driving circuit further includes an output module, a pull-down control module, and a reset module. The output module includes an output transistor and a first capacitor. A control terminal of the output transistor is electrically connected to the first node, an input terminal of the output transistor is electrically connected to a high-frequency clock signal terminal, and an output terminal of the output transistor is electrically connected to a signal output terminal of the gate driving circuit. The first capacitor is in series between the first node and the signal output terminal. The pull-down control module includes a first pull-down transistor, a control terminal of the first pull-down transistor is configured to receive a pull-down control signal, an input terminal of the first pull-down transistor is electrically connected to the first voltage terminal, and an output terminal of the first pull-down transistor is electrically connected to the first node. The reset module includes a first reset transistor and a second reset transistor. A control terminal of the first reset transistor and a control terminal of the second reset transistor are configured to receive a reset control signal, an input terminal of the first reset transistor and an input terminal of the second reset transistor are electrically connected to the first voltage terminal, an output terminal of the first reset transistor is electrically connected to the first node, and an output terminal of the second reset transistor is electrically connected to a signal output terminal of the gate driving circuit.

Optionally, in some embodiments, a voltage of a low-frequency clock signal transmitted by the low-frequency clock signal terminal during a sensing phase of the display panel is less than a voltage of the low-frequency clock signal during a display phase of the display panel.

In the gate driving circuit and the display panel provided in the present disclosure, the pull-up control module is electrically connected to the first voltage terminal, the first node, and the second node, the inverting module is electrically connected to the first voltage terminal, the first node, the second node, and the third node, the pull-down holding module is electrically connected to the first voltage terminal, the first node, and the third node, so that when the pull-up control module is electrically connected to the first voltage terminal and the third node in response to the pull-up control signal, the inverting module is configured to disconnect an electrical connection between the low-frequency clock signal terminal and the third node in response to the potential of the second node, the inverting module is configured to control an electrical connection between the first voltage terminal and the third node in response to the potential of the first node, and the pull-down holding module is configured to disconnect an electrical connection between the first voltage terminal and the first node in response to the potential of the third node, so that when the pull-up control module is electrically connected to the first voltage terminal and the third node in response to the pull-up control signal, a low-frequency clock signal transmitted by the low-frequency clock signal terminal no longer acts on the third node, and only a first voltage signal supplied by the first voltage terminal acts on the third node, improving a control speed of the pull-down holding module disconnecting the electrical connection between the first voltage terminal and the first node, thereby improving the problems of temperature rise and reduced reliability of the gate driving circuit.

Specifically, FIG. 1 is a schematic block diagram f of a gate driving circuit provided by an embodiment of the present disclosure. Embodiments of the present disclosure provide a gate driving circuit. The gate driving circuit includes an inverting module 10, a pull-down holding module 20, and a pull-up control module 30.

The inverting module 10 is electrically connected to a first voltage terminal VGL, a first node N1, a second node N2, and a third node N3. The inverting module 10 is configured to control a signal transmission between the first voltage terminal VGL and the third node N3 in response to a potential of the first node N1, and is configured to control a signal transmission between a low-frequency clock signal terminal LC and the third node N3 in response to a potential of the second node N2.

The pull-down holding module 20 is electrically connected to the first voltage terminal VGL, the first node N1, and the third node N3. The pull-down holding module 20 is configured to control a signal transmission between the first voltage terminal VGL and the first node N1 in response to a potential of the third node N3.

The pull-up control module 30 is electrically connected to the first voltage terminal VGL, the first node N1, and the second node N2. The pull-up control module 30 is configured to pull up the potential of the first node N1 in response to a pull-up control signal UCS, and configured to control a signal transmission between the first voltage terminal VGL and the second node N2 in response to the pull-up control signal UCS.

When the pull-up control module 30 is configured to electrically connect the first voltage terminal VGL and the second node N2 in response to the pull-up control signal UCS, the inverting module 10 is configured to disconnect an electrical connection between the low-frequency clock signal terminal LC and the third node N3 in response to the potential of the second node N2, the inverting module 10 is configured to control an electrical connection between the first voltage terminal VGL and the third node N3 in response to the potential of the first node N1, and the pull-down holding module 20 is configured to disconnect an electrical connection between the first voltage terminal VGL and the first node N1 in response to the potential of the third node N3, so that when the pull-up control module 30 is configured to electrically connect the first voltage terminal VGL and the second node N2 in response to the pull-up control signal UCS, the low-frequency clock signal transmitted by the low-frequency clock signal terminal LC no longer acts on the third node N3, and only the first voltage signal supplied by the first voltage terminal VGL acts on the third node N3, so that the pull-down holding module 20 disconnects the electrical connection between the first voltage terminal VGL and the first node N1 only in response to the first voltage signal, which is beneficial to making the electrical connection between the first voltage terminal VGL and the first node N1 be disconnected in advance, thereby improving the problems of temperature rise and reduced reliability of the gate driving circuit.

Optionally, please continue to refer to FIG. 1, in some embodiments, the pull-up control module 30 includes a first control unit 301 and a second control unit 302. The first control unit 301 is configured to pull up the potential of the first node N1 in response to the pull-up control signal UCS, and the second control unit 302 is configured to control the signal transmission between the first voltage terminal VGL and the second node N2 in response to the pull-up control signal UCS.

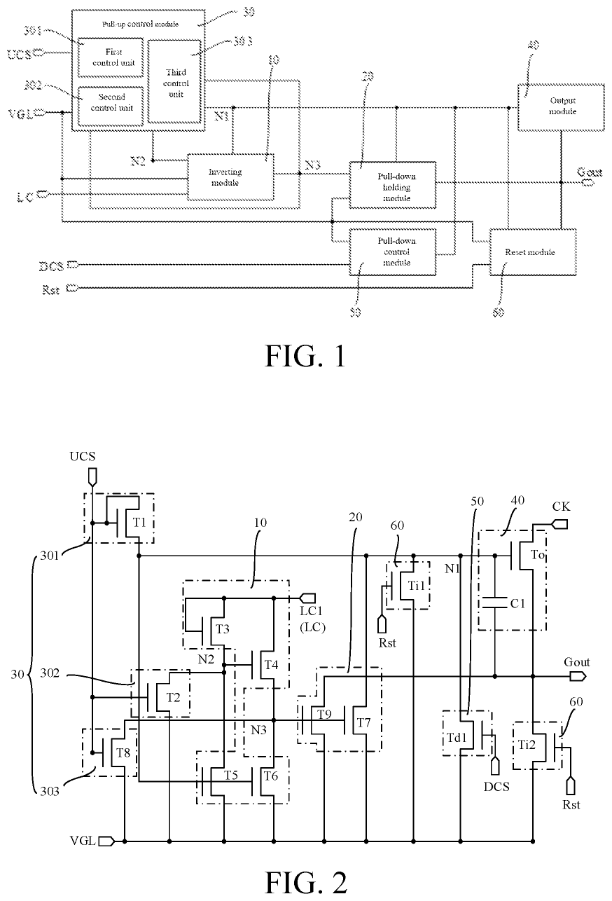

FIG. 2 is a schematic structural diagram of a gate driving circuit provided by an embodiment of the present disclosure. Optionally, in some embodiments, the first control unit 301 includes a first transistor T1, and the second control unit 302 includes a second transistor T2.

A control terminal of the first transistor T1 is configured to receive the pull-up control signal UCS, an input terminal of the first transistor T1 is electrically connected to the control terminal of the first transistor T1, and an output terminal of the first transistor T1 is electrically connected to the first node N1.

A control terminal of the second transistor T2 is configured to receive the pull-up control signal UCS. An input terminal of the second transistor T2 is electrically connected to the first voltage terminal VGL. An output terminal of the second transistor T2 is electrically connected to the second node N2.

Please continue to refer to FIG. 2, in some embodiments, the inverting module 10 includes an inverting unit, and the inverting unit includes a third transistor T3, a fourth transistor T4, a fifth transistor T5, and a sixth transistor T6.

A control terminal of the third transistor T3 is electrically connected to the low-frequency clock signal terminal LC, an input terminal of the third transistor T3 is electrically connected to the control terminal of the third transistor T3, and an output terminal of the third transistor T3 is electrically connected to the second node N2.

A control terminal of the fourth transistor T4 is electrically connected to the second node N2, an input terminal of the fourth transistor T4 is electrically connected to the low-frequency clock signal terminal LC, and an output terminal of the fourth transistor T4 is electrically connected to the third node N3.

A control terminal of the fifth transistor T5 is electrically connected to the first node N1, an input terminal of the fifth transistor T5 is electrically connected to the first voltage terminal VGL, and an output terminal of the fifth transistor T5 is electrically connected to the second node N2.

A control terminal of the sixth transistor T6 is electrically connected to the first node N1, an input terminal of the sixth transistor T6 is electrically connected to the first voltage terminal VGL, and an output terminal of the sixth transistor T6 is electrically connected to the third node N3.

The third transistor T3 is configured to control the signal transmission between the low-frequency clock signal terminal LC and the second node N2 in response to the low-frequency clock signal transmitted by the low-frequency clock signal terminal LC. The fourth transistor T4 is configured to control the signal transmission between the low-frequency clock signal terminal LC and the third node N3 in response to the potential of the second node N2. The fifth transistor T5 is configured to control the signal transmission between the first voltage terminal VGL and the second node N2 in response to the potential of the first node N1. The sixth transistor T6 is configured to control the signal transmission between the first voltage terminal VGL and the third node N3 in response to the potential of the first node N1.

Please continue to refer to FIG. 2, in some embodiments, the pull-down holding module 20 includes a pull-down holding unit, and the pull-down holding unit includes a seventh transistor T7. A control terminal of the seventh transistor T7 is electrically connected to the third node N3, an input terminal of the seventh transistor T7 is electrically connected to the first voltage terminal VGL, and an output terminal of the seventh transistor T7 is electrically connected to the first node N1.

Optionally, please continue to refer to FIG. 1, in some embodiments, the pull-up control module 30 further includes a third control unit 303, and the third control unit 303 is configured to control the signal transmission between the first voltage terminal VGL and the third node N3 in response to the pull-up control signal UCS, so as to improve a control speed of the pull-down holding module 20 disconnecting the electrical connection between the first voltage terminal VGL and the first node N1 when the pull-up control module 30 electrically connects the first voltage terminal VGL and the second node N2 in response to the pull-up control signal UCS, thereby further improving the problems of temperature rise and reduced reliability of the gate driving circuit.

Please continue to refer to FIG. 2, in some embodiments, the third control unit 303 includes an eighth transistor T8. A control terminal of the eighth transistor T8 is configured to receive the pull-up control signal UCS, an input terminal of the eighth transistor T8 is electrically connected to the first voltage terminal VGL, and an output terminal of the eighth transistor T8 is electrically connected to the third node N3.

Optionally, in some embodiments, the pull-down holding module 20 is also electrically connected to a signal output terminal Gout of the gate driving circuit, and the pull-down holding module 20 is further configured to control a signal transmission between a first signal terminal and the signal output terminal Gout in response to the potential of the third node N3.

Correspondingly, please continue to refer to FIG. 2, in some embodiments, the pull-down holding module 20 includes a ninth transistor T9. A control terminal of the ninth transistor T9 is electrically connected to the third node N3, an input terminal of the ninth transistor T9 is electrically connected to the first voltage terminal VGL, and an output terminal of the ninth transistor T9 is electrically connected to the signal output terminal Gout of the gate driving circuit.

Optionally, in some embodiments, the pull-down holding module 20 may multiplex the seventh transistor T7 by electrically connecting the output terminal of the seventh transistor T7 with the signal output terminal Gout to omit the ninth transistor T9, thereby reducing a number of the transistors included in the gate driving circuit.

Please continue to refer to FIG. 1, the gate driving circuit also includes an output module 40. The output module 40 is electrically connected to the first node N1 and the signal output terminal Gout of the gate driving circuit. The output module 40 is configured to control a signal transmission between a high-frequency clock signal terminal CK and the signal output terminal Gout in response to the potential of the first node N1.

Correspondingly, please continue to refer to FIG. 2, in some embodiments, the output module 40 includes an output transistor To and a first capacitor C1. A control terminal of the output transistor To is electrically connected to the first node N1, an input terminal of the output transistor To is electrically connected to the high-frequency clock signal terminal CK, and an output terminal of the output transistor To is electrically connected to the signal output terminal Gout of the gate driving circuit. The first capacitor Cl is in series between the first node N1 and the signal output terminal Gout.

Please continue to refer to FIG. 1, in some embodiments, the gate driving circuit further includes a pull-down control module 50. The pull-down control module 50 is electrically connected to the first node N1 and the first voltage terminal VGL. The pull-down control module 50 is configured to control the signal transmission between the first node N1 and the first voltage terminal VGL in response to a pull-down control signal DCS.

Accordingly, please continue to refer to FIG. 2, in some embodiments, the pull-down control module 50 includes a first pull-down transistor Td1. A control terminal of the first pull-down transistor Td1 is configured to receive the pull-down control signal DCS, an input terminal of the first pull-down transistor Td1 is electrically connected to the first voltage terminal VGL, and an output terminal of the first pull-down transistor Td1 is electrically connected to the first node N1.

Optionally, in some embodiments, the pull-down control module 50 is also electrically connected to the signal output terminal Gout of the gate driving circuit, and the pull-down control module 50 is further configured to control a signal transmission between the first voltage terminal VGL and the signal output terminal Gout in response to the pull-down control signal DCS.

Correspondingly, the pull-down control module 50 includes a second pull-down transistor. A control terminal of the second pull-down transistor is configured to receive the pull-down control signal DCS, an input terminal of the second pull-down transistor is connected to the first voltage terminal VGL, and an output terminal of the second pull-down transistor is electrically connected to the signal output terminal Gout.

Please continue to refer to FIG. 1, in some embodiments, the gate driving circuit further includes a reset module 60. The reset module 60 is electrically connected to the first node N1, the first voltage terminal VGL, and the signal output terminal Gout of the gate driving circuit. The reset module 60 is configured to control a signal transmission between the first voltage terminal VGL and at least one of the first node N1 and the signal output terminal Gout in response to a reset control signal Rst.

Optionally, please continue to refer to FIG. 2, in some embodiments, the reset module 60 includes a first reset transistor Ti1 and a second reset transistor Ti2. A control terminal of the first reset transistor Ti1 and a control terminal of the second reset transistor Ti2 are configured to receive the reset control signal Rst. An input terminal of the first reset transistor Ti1 and an input terminal of the second reset transistor Ti2 are electrically connected to the first voltage terminal VGL. An output terminal of the first reset transistor Ti1 is electrically connected to the first node N1, and an output terminal of the second reset transistor Ti2 is connected to the signal output terminal Gout of the gate driving circuit.

Optionally, in some embodiments, the reset module 60 may include one of the first reset transistor Ti1 and the second reset transistor Ti2.

Optionally, in some embodiments, the reset module 60 includes a reset transistor. A control terminal of the reset transistor is configured to receive the reset control signal Rst, an input terminal of the reset transistor is electrically connected to the first voltage terminal VGL, and an output terminal of the reset transistor is electrically connected to at least one of the first node N1 and the signal output terminal Gout. By electrically connecting the output terminal of the reset transistor to the first node N1 and the signal output terminal Gout, the number of the transistors included in the gate driving circuit can be reduced, saving costs while also realizing a narrow frame of a display panel when the gate driving circuit is applied to the display panel.

Optionally, in some embodiments, the gate driving circuit further includes a cascade transmission module. The cascade transmission module is electrically connected to the first node N1, the high-frequency clock signal terminal CK, and a cascade transmission output terminal of the gate driving circuit. The cascade transmission module is configured to control a signal transmission between the high-frequency clock signal terminal CK and the cascade transmission output terminal in response to the potential of the first node N1.

Optionally, the cascade transmission module includes a cascade transistor. A control terminal of the cascade transistor is electrically connected to the first node N1, an input terminal of the cascade transistor is electrically connected to the high-frequency clock signal terminal CK, and an output terminal of the cascade transistor is electrically connected to the cascade transmission output terminal.

Optionally, in some embodiments, the pull-down holding module 20 further includes a tenth transistor. A control terminal of the tenth transistor is electrically connected to the third node N3, an input terminal of the tenth transistor is electrically connected to the first voltage terminal VGL, and an output terminal of the tenth transistor is electrically connected to the cascade transmission output terminal.

Optionally, in some embodiments, the reset module 60 further includes a third reset transistor. A control terminal of the third reset transistor is configured to receive the reset control signal Rst, an input terminal of the third reset transistor is electrically connected to the first voltage terminal VGL, and an output terminal of the third reset transistor is electrically connected to the cascade transmission output terminal.

It can be understood that, in order to reduce the number of the transistors included in the gate driving circuit, the tenth transistor may be omitted by multiplexing the seventh transistor T7. That is, the output terminal of the seventh transistor T7 is also electrically connected to the cascade transmission output terminal. Similarly, the third reset transistor may be omitted by multiplexing the reset transistor. That is, the output terminal of the reset transistor is also electrically connected to the cascade transmission output terminal.

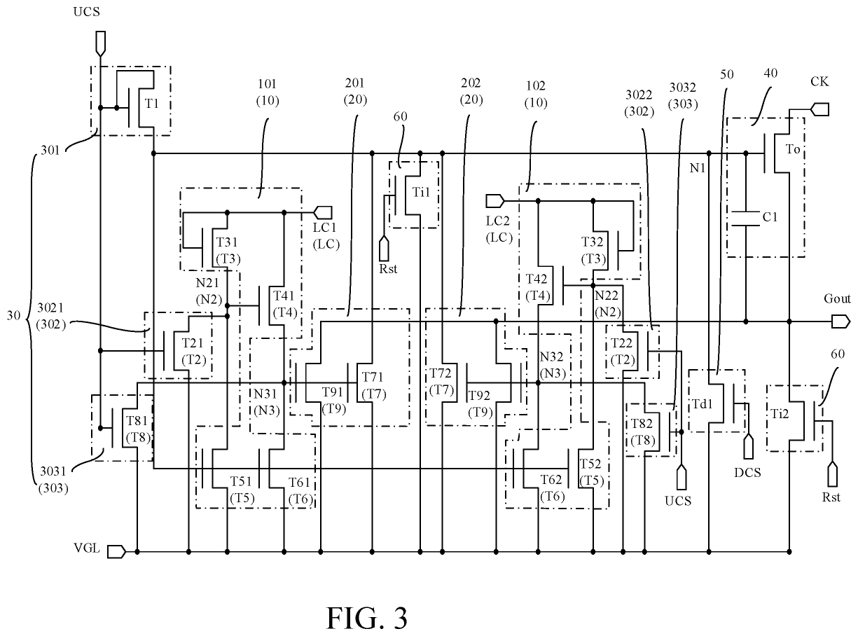

FIG. 3 is a schematic structural diagram of another gate driving circuit provided by an embodiment of the present disclosure. In some embodiments, the gate driving circuit may be provided with two inverting units, and the two inverting units operate in turn for a certain interval to prolong a life cycle of the gate driving circuit. Correspondingly, in order to match an arrangement of the two inverting units, the pull-down holding module 20 includes two pull-down holding units, the second control unit 302 of the pull-up control module 30 may include two control sub-units, and the third control unit 303 of the pull-up control module 30 may include two control sub-units.

Correspondingly, the second node N2 includes a first sub-node N21 and a second sub-node N22, and the third node N3 includes a third sub-node N31 and a fourth sub-node N32. The low-frequency clock signal terminal LC includes a first low-frequency clock signal terminal LC1 and a second low-frequency clock signal terminal LC2.

The inverting module 10 includes a first inverting unit 101 and a second inverting unit 102. In the first inverting unit 101, the output terminal of the third transistor T31, the control terminal of the fourth transistor T41, and the output terminal of the fifth transistor T51 are electrically connected to the first sub-node N21, the output terminal of the fourth transistor T41 and the output terminal of the sixth transistor T61 are electrically connected to the third sub-node N31, and the control terminal of the third transistor T31 and the input terminal of the fourth transistor T41 are electrically connected to the first low-frequency clock signal terminal LC1. In the second inverting unit 102, the output terminal of the third transistor T32, the control terminal of the fourth transistor T42, and the output terminal of the fifth transistor T52 are electrically connected to the second sub-node N22, the output terminal of the fourth transistor T42 and the output terminal of the sixth transistor T62 are electrically connected to the fourth sub-node N32, and the control terminal of the third transistor T32 and the input terminal of the fourth transistor T42 are electrically connected to the second low-frequency clock signal terminal LC2.

The pull-down holding module 20 includes a first pull-down holding unit 201 and a second pull-down holding unit 202. The control terminal of the seventh transistor T71 of the first pull-down holding unit 201 is electrically connected to the third sub-node N31, and the control terminal of the seventh transistor T72 of the second pull-down holding unit 202 is electrically connected to the fourth sub-node N32.

Optionally, in some embodiments, the control terminal of the ninth transistor T91 of the first pull-down holding unit 201 is electrically connected to the third sub-node N31, and the control terminal of the ninth transistor T92 of the second pull-down holding unit 202 is electrically connected to the fourth sub-node N32.

The second control unit 302 of the pull-up control module 30 includes a first control sub-unit 3021 and a second control sub-unit 3022. The output terminal of the second transistor T21 of the first control sub-unit 3021 is electrically connected to the first sub-node N21, and the output terminal of the second transistor T22 of the second control sub-unit 3022 is electrically connected to the second sub-node N22.

The third control unit 303 of the pull-up control module 30 includes a third control sub-unit 3031 and a fourth control sub-unit 3032. The output terminal of the eighth transistor T81 of the third control sub-unit 3031 is electrically connected to the third sub-node N31, and the output terminal of the eighth transistor T82 of the fourth control sub-unit 3032 is electrically connected to the fourth sub-node N32.

It should be noted that the second transistor T21 of the first control sub-unit 3021 and the second transistor T22 of the second control sub-unit 3022 are two transistors, rather than multiplexing one transistor. Similarly, the third transistor T31 of the first inversion unit 101 and the third transistor T32 of the second inversion unit 102 are two transistors, the fourth transistor T41 of the first inversion unit 101 and the fourth transistor T42 of the second inverting unit 102 are two transistors, the fifth transistor T51 of the first inverting unit 101 and the fifth transistor T52 of the second inverting unit 102 are two transistors, and the sixth transistor T61 of the first inversion unit 101 and the sixth transistor T62 of the second inversion unit 102 are two transistors. The seventh transistor T71 of the first pull-down holding unit 201 and the seventh transistor T72 of the second pull-down holding unit 202 are two transistors. The eighth transistor T81 of the third control sub-unit 3031 and the eighth transistor T82 of the fourth control sub-unit 3032 are two transistors. The ninth transistor T91 of the first pull-down holding unit 201 and the ninth transistor T92 of the second pull-down holding unit 202 are two transistors.

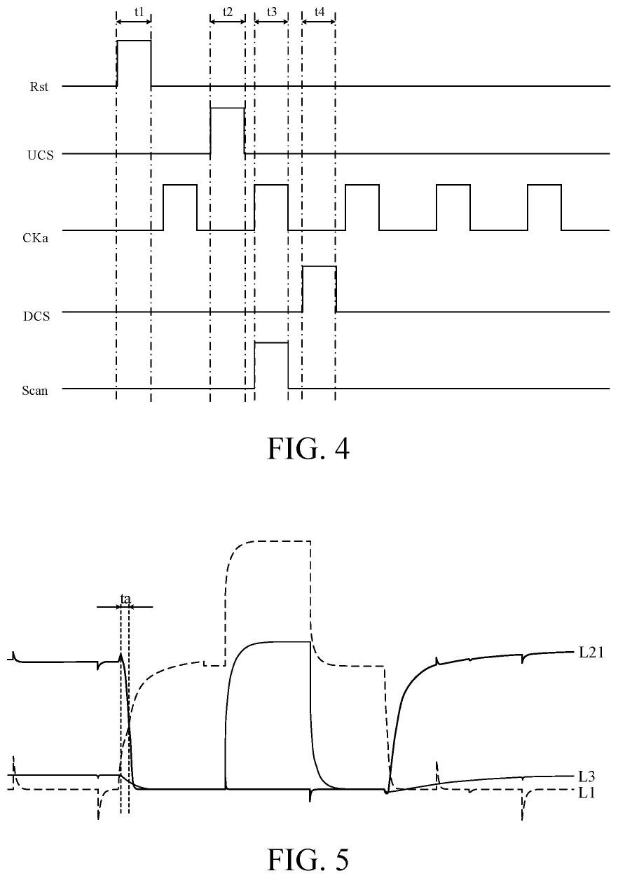

FIG. 4 is a timing diagram of a corresponding gate driving circuit provided by an embodiment of the present disclosure. That each transistor included in the gate driving circuit is an N-type transistor and the low-frequency clock signal transmitted by the low-frequency clock signal terminal LC in the gate driving circuit illustrated in FIG. 2 are taken as an example to describe a working principle of the gate driving circuit illustrated in FIG. 2.

During a first stage t1: the reset signal Rst has a high-level state, and the pull-up control signal UCS, the high-frequency clock signal CKa transmitted by the high-frequency clock signal terminal CK, and the pull-down control signal DCS have a low-level state. The first reset transistor Ti1 and the second reset transistor Ti2 turn on, and the first voltage terminal VGL is electrically connected to the first node N1 and the signal output terminal Gout.

During a second stage t2: the pull-up control signal UCS has a high-level state, and the high-frequency clock signal CKa transmitted by the high-frequency clock signal terminal CK and the pull-down control signal DCS have a low-level state. The first transistor T1, the second transistor T2, the output transistor To, the fifth transistor T5, the sixth transistor T6, and the eighth transistor T8 turn on. The fourth transistor T4, the seventh transistor T7, the ninth transistor T9, the first pull-down transistor Td1, the first reset transistor Ti1, and the second reset transistor Ti2 turn off.

During a third stage t3: the high-frequency clock signal CKa has a high-level state, and the pull-up control signal UCS and the pull-down control signal DCS have a low-level state. The first transistor T1, the second transistor T2, and the eighth transistor T8 turn off. The output transistor To, the fifth transistor T5, and the sixth transistor T6 remain on. The fourth transistor T4, the seventh transistor T7, the ninth transistor T9, and the first pull-down transistor Td1 remain off. A gate control signal Scan output by the signal output terminal Gout has a high-level state.

During a fourth stage t4: the pull-down control signal DCS has a high-level state, and the pull-up control signal UCS and the high-frequency clock signal CKa have a low-level state. The first transistor T1, the second transistor T2, and the eighth transistor T8 remain off. The first pull-down transistor Td1 turns on. The output transistor To, the fifth transistor T5, and the eighth transistor T8 turn off. The third transistor T3, the fourth transistor T4, the seventh transistor T7, and the ninth transistor T9 turn on.

In the gate driving circuit illustrated in FIG. 3, the first low-frequency clock signal LCa supplied by the first low-frequency clock signal terminal LC1 may have one of a high-level state and a low-level state, and the second low-frequency clock signal LCb supplied by the clock signal terminal LC2 may have the other one of the high-level state and the low-level state.

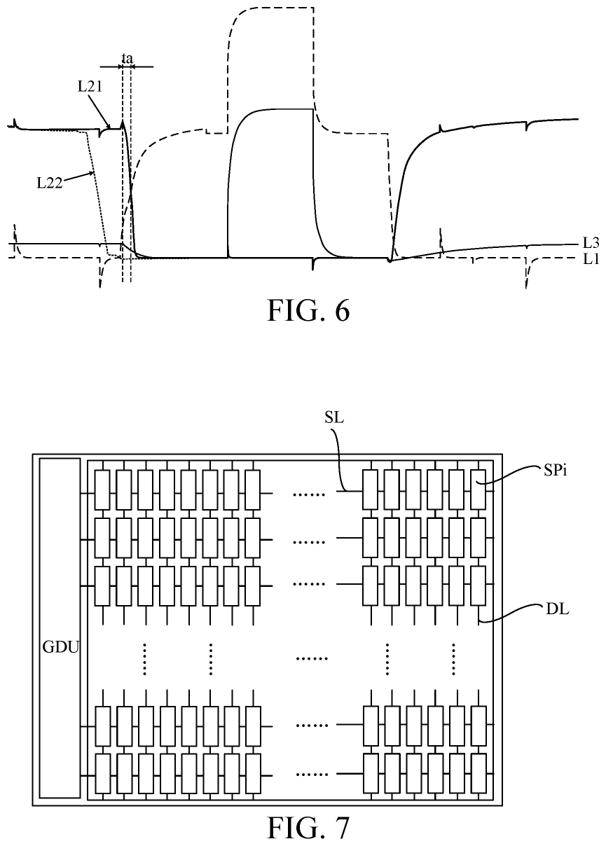

FIG. 5 is a simulation timing diagram before the improvement of a corresponding gate driving circuit provided by an embodiment of the present disclosure, and FIG. 6 is a simulation timing diagram after the improvement of a corresponding gate driving circuit provided by an embodiment of the present disclosure. L1 represents a potential change curve of the first node N1, L21 represents a potential change curve of the second node N2 before the improvement, L22 represents a potential change curve of the second node N2 after the improvement, and L3 represents the gate control signal Scan output by the signal output terminal Gout. The present disclosure conducts a simulation analysis of the gate driving circuit before and after the improvement. The simulation results show that before the improvement, there is an overlapping time period ta between the potential rising process of the first node N1 and the potential falling process of the second node N2, causing the seventh transistor T7 to turn on during the corresponding time period ta, causing a leakage path between the first node N1 and the first voltage terminal VGL. After the improvement, before the potential of the first node N1 is pulled up, the potential of the second node N2 may be pulled down to a voltage corresponding to the first voltage terminal VGL under the control of the pull-up control module 30, so that during the potential rising process of the first node N1, the leakage between the first node N1 and the first voltage terminal VGL is reduced, the potential raising effect of the first node N1 is improved, and then the problems of temperature rise and reduced reliability of the gate driving circuit are improved.

FIG. 7 is a schematic structural diagram of a display panel provided by an embodiment of the present disclosure. The present disclosure also provides a display panel including a gate drive unit GDU, and the gate drive unit (such as GDC illustrated in FIG. 7) includes a plurality of any of the above gate driving circuits.

Please continue to refer to FIG. 7, the display panel includes a plurality of sub-pixels Spi, a plurality of scan lines SL, and a plurality of data lines DL. The plurality of sub-pixels Spi are electrically connected to the gate driving unit GDU, the plurality of scan lines SL, and the plurality of data lines DL. The plurality of sub-pixels Spi realize display in response to a plurality of gate control signals output by the gate driving unit GDU. The plurality of gate control signals are transmitted to the plurality of sub-pixels Spi through the scan lines SL.

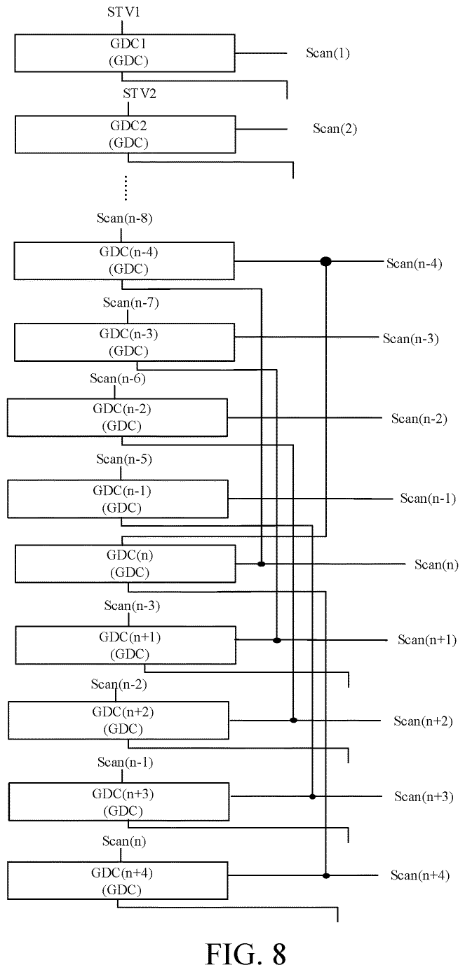

FIG. 8 is a cascade relationship diagram of a plurality of gate driving circuits provided by an embodiment of the present disclosure. Optionally, in some embodiments, the plurality of gate driving circuits are arranged in cascade. The pull-up control signals UCS received by first x stages of gate driving circuits of the plurality of cascaded gate driving circuits are provided by a control chip or other device.

For example, the pull-up control signals UCS received by the first two stages of gate driving circuits of the plurality of cascaded gate driving circuits are provided by the control chip. That is, the control chip generates a first start signal STV1 and a second start signal STV2. The first start signal STV1 serves as the pull-up control signal UCS received by a first stage gate driving circuit GDC1 of the plurality of cascaded gate driving circuits. The second start signal STV2 serves as the pull-up control signal UCS received by a second stage gate driving circuit GDC2 of the plurality of cascaded gate driving circuits.

Optionally, the control chip includes a timing controller and the like.

Optionally, an (n−p)th stage gate control signal Scan(n−p) output by the signal output terminal Gout of an (n−p)th stage gate driving circuit GDC(n−p) or an (n−p)th stage cascade control signal output by the cascade transmission output terminal of the (n−p)th stage gate driving circuit GDC(n−p) correspondly serves as the pull-up control signal UCS received by an n-th stage gate driving circuit GDC(n), where n>1, and m≥1.

Optionally, an (n−4)th stage gate control signal Scan(n−4) output by an (n−4)th stage gate driving circuit GDC(n−4) serves as the pull-up control signal UCS received by the pull-up control module 30 of the n-th stage gate driving circuit GDC(n).

Optionally, in some embodiments, an (n+q)th stage gate control signal Scan(n+q) output by the signal output terminal Gout of an (n+q)th stage gate driving circuit GDC(n+q) or an (n+q)th stage cascade control signal output by the cascade transmission output terminal of the (n+q)th stage gate driving circuit GDC(n+q) correspondly serves as the pull-up control signal UCS received by the n-th stage gate driving circuit GDC(n), where q≥1.

Optionally, an (n+4)th stage gate control signal Scan(n+4) output by an (n+4)th stage gate driving circuit GDC(n+4) serves as the pull-down control signal DCS received by the pull-up control module 30 of the n-th stage gate driving circuit GDC(n).

Optionally, in some embodiments, the plurality of gate driving circuits share the low-frequency clock signal supplied by the low-frequency clock signal terminal LC. That is, the plurality of gate driving circuits are electrically connected to the low-frequency clock signal terminal LC. Furthermore, the plurality of gate driving circuits are electrically connected to the first low-frequency clock signal terminal LC1 and the second low-frequency clock signal terminal LC2.

Optionally, in some embodiments, the plurality of gate driving circuits share a plurality of high-frequency clock signals CKa to save frame layout space while reducing a number of the high-frequency clock signals CKa applied to the display panel.

Optionally, the plurality of gate driving circuits share y high-frequency clock signals CKa, and where y is 2, 4, 6, 8, 12, etc.

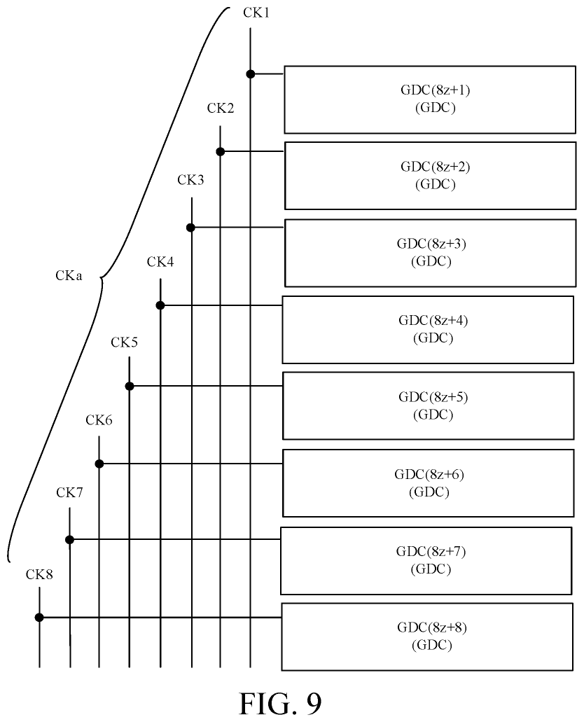

FIG. 9 is a schematic diagram showing a corresponding relationship between gate driving circuits and high-frequency clock signals provided by an embodiment of the present disclosure. Optionally, in some embodiments, the plurality of gate driving circuits share 8 high-frequency clock signals CKa. The high-frequency clock signal CKa received by an (8z+1) stage gate driving circuit GDC(8z+1) corresponds to a first high-frequency clock signal CK1, the high-frequency clock signal CKa received by an (8z+2) stage gate driving circuit GDC(8z+2) corresponds to a second high-frequency clock signal CK2, the high-frequency clock signal CKa received by an (8z+3) stage gate driving circuit GDC(8z+3) corresponds to a third high-frequency clock signal CK3, the high-frequency clock signal CKa received by an (8z+4) stage gate driving circuit GDC(8z+4) corresponds to a fourth high-frequency clock signal CK4, the high-frequency clock signal CKa received by an (8z+5) stage gate driving circuit GDC(8z+5) corresponds to a fifth high-frequency clock signal CK5, the high-frequency clock signal CKa received by an (8z+6) stage gate driving circuit GDC(8z+6) corresponds to a sixth high-frequency clock signal CK6, the high-frequency clock signal CKa received by an (8z+7) stage gate driving circuit GDC(8z+7) corresponds to a seventh high-frequency clock signal CK7, and the high-frequency clock signal CKa received by an (8z+8) stage gate driving circuit GDC(8z+8) corresponds to an eighth high-frequency clock signal CK8, where z≥0.

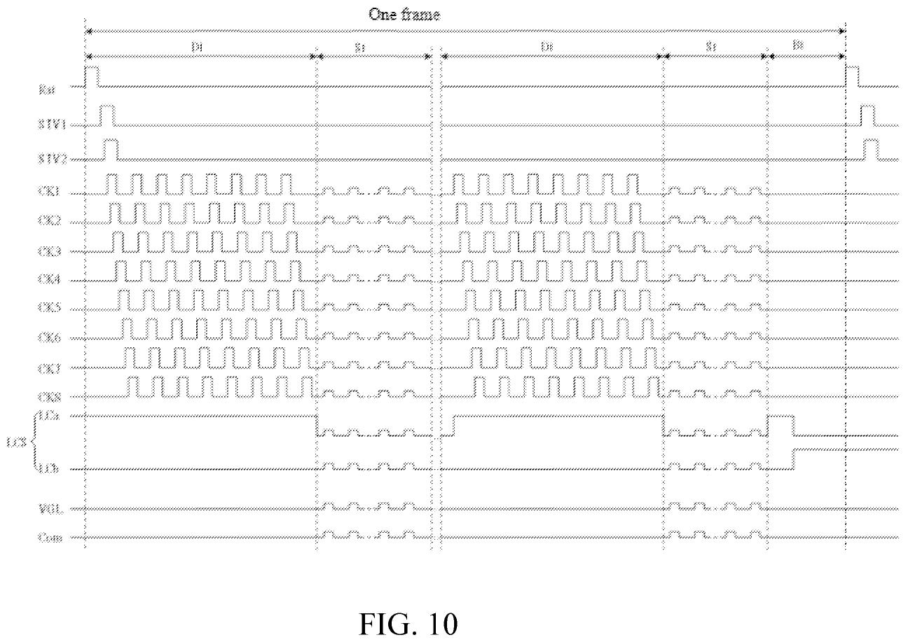

FIG. 10 is a driving timing diagram of a display panel provided by an embodiment of the present disclosure. Optionally, in some embodiments, in addition to supporting a display function, the display panel also supports functions including a touch function. Therefore, within one frame duration, at least one display phase Dt and at least one sensing phase St may be included. In some embodiments, the sensing phase St may correspond to a touch phase.

However, when the display panel enters the sensing phase St from the display phase Dt, the potential of the first node N1 of each gate driving circuit in some stages has been pulled up, but the corresponding received high-frequency clock signal CKa does not have a high-level state, so that the output gate control signal does not have a valid-level state. Therefore, when the display panel re-enters the display phase Dt from the sensing phase St, it is necessary to resume operation of the gate driving circuits in the some stages, and then enable the gate control signals output by the plurality of gate driving circuits to meet the display requirement.

During the sensing phase St, on a condition that the potential of the first node N1 of each gate driving circuit in the some stages changes, a conduction degree of the output transistor To may change, and then when the sensing phase St re-enters the display phase Dt, voltages of the gate control signals output by the gate driving circuits of the some stages corresponding to the valid-level state are different, thereby causing charging differences of the sub-pixels in corresponding rows in the display panel, and resulting in problems such as horizontal lines on the display.

During the sensing phase St, on a condition that the potential change of the first node N1 of each gate driving circuit in the some stages causes the output transistor To to turn off, then when the sensing phase St re-enters the display phase Dt, the gate control signals output by the gate driving circuits in the some stages may not have the valid-level state, and since the pull-up control signals UCS corresponding to the gate driving circuits in multiply stages cascaded thereafter do not have the valid-level state, the gate driving circuits in the multiply stages cascaded thereafter also output the gate control signals that does not have the valid-level state. As a result, the sub-pixel in the corresponding rows in the display panel cannot perform the charging action, and then the display is abnormal.

Therefore, during the sensing phase St, it is necessary to keep the potential of the first node N1 of each gate driving circuit in at least part of the stages stable, so that when the display panel re-enters the display phase Dt from the sensing phase St, multiple gate control signals output by the gate driving circuits in multiply stages normally have the valid-level state, thereby improving the display problems.

Therefore, during the sensing phase St, by controlling the low-frequency clock signal corresponding to the low-frequency clock signal terminal LC, the pull-down holding module 20 maintains disconnecting the electrical connection between the first voltage terminal VGL and the first node N1, thereby keeping the potential of the first node N1 of each gate driving circuit in at least part of the stages stable.

Optionally, in some embodiments, a voltage of the low-frequency clock signal LCS transmitted by the low-frequency clock signal terminal LC during the sensing phase St of the display panel is less than a voltage of the low-frequency clock signal LCS during the display phase Dt of the display panel, so that the potential of the first node N1 of each gate driving circuit in at least part of the stages remains stable.

Optionally, during the sensing phase St, the low-frequency clock signal LCS may jump between a first voltage and a second voltage, but in order to keep the potential of the first node N1 of each gate driving circuit in at least part of the stages stable, both the first voltage and the second voltage are less than the voltage of the low-frequency clock signal LCS during the display phase Dt of the display panel.

Optionally, in some embodiments, when the first inverting unit 101 is operating and the second inverting unit 102 is not operating, a voltage of the first low-frequency clock signal LCa transmitted by the first low-frequency clock signal terminal LC1 during the sensing phase St of the display panel is less than a voltage of the first low-frequency clock signal LCa during the display phase Dt of the display panel, so that the potential of the first node N1 of each gate driving circuit in at least part of the stages remains stable.

Optionally, in some embodiments, when the first inverting unit 101 is not operating and the second inverting unit 102 is operating, a voltage of the second low-frequency clock signal LCb transmitted by the second low-frequency clock signal terminal LC2 during the sensing phase St of the display panel is less than a voltage of the second low-frequency clock signal LCb during the display phase Dt of the display panel, so that the potential of the first node N1 of each gate driving circuit in at least part of the stages remains stable.

Optionally, during the display phase Dt, the first low-frequency clock signal LCa and the second low-frequency clock signal LCb are inverted, so that only one of the inverting units operates in one display phase Dt.

Optionally, during the display phases Dt of consecutive t frames, the first low-frequency clock signal LCa has one of a high-level state and a low-level state, and the second low-frequency clock signal LCb has the other one of the high-level state and the low-level state.

Optionally, when the display panel displays t frames of data every time, the first low-frequency clock signal LCa jumps from a first level state to a second level state, and the second low-frequency clock signal LCb jumps from the second level state to the first level state. The first level state is one of the high-level state and the low-level state, and the second level state is the other one of the high-level state and the low-level state. Optionally, t may be 100.

Optionally, during a blanking interval phase, the first low-frequency clock signal LCa has a jump between the first level state and the second level state, and the second low-frequency clock signal LCb has a jump between the second level state and the first level state.

Optionally, the blanking interval phase includes a vertical blanking interval phase Bt.

Optionally, the reset control signal Rst may have a valid-level state at the beginning of each frame, so that the reset module 60 controls the first voltage terminal VGL of the gate driving circuit to be electrically connected to at least one of the first node N1 and the signal output terminal Gout in response to the reset control signal Rst.

Optionally, the plurality of gate driving circuits share the same reset control signal Rst, so as to reduce a number of the control signals included in the gate driving unit and reduce the control complexity of the display panel.

It can be understood that when the gate driving circuit applied in the display panel includes the cascade transmission module, an arrangement and corresponding effect of each gate driving circuit in the gate drive unit can be obtained by referring to the description of the gate driving circuit that does not include the cascade transmission module corresponding to similar reasoning, so it is not repeated here.

This paper uses specific examples to illustrate the principles and implementation methods of the present disclosure. The description of the above embodiments is only used to help understand the method and its core idea of the present disclosure. At the same time, for those skilled in the art, there will be changes in the specific implementation and application scope based on the ideas of the present disclosure. In summary, the content of this description should not be understood as a limitation of the present disclosure.

1. A gate driving circuit, comprising:
an inverting module, electrically connected to a first voltage terminal, a first node, a second node, and a third node, configured to control a signal transmission between the first voltage terminal and the third node in response to a potential of the first node, and configured to control a signal transmission between a low-frequency clock signal terminal and the third node in response to a potential of the second node;
a pull-down holding module, electrically connected to the first voltage terminal, the first node, and the third node, and configured to control a signal transmission between the first voltage terminal and the first node in response to a potential of the third node; and
a pull-up control module, electrically connected to the first voltage terminal, the first node, and the second node, configured to pull up the potential of the first node in response to a pull-up control signal, and configured to control a signal transmission between the first voltage terminal and the second node in response to the pull-up control signal,
wherein when the pull-up control module is configured to electrically connect the first voltage terminal and the second node in response to the pull-up control signal, the inverting module is configured to disconnect an electrical connection between the low-frequency clock signal terminal and the third node in response to the potential of the second node, the inverting module is also configured to control an electrical connection between the first voltage terminal and the third node in response to the potential of the first node, and the pull-down holding module is configured to disconnect an electrical connection between the first voltage terminal and the first node in response to the potential of the third node.

2. The gate driving circuit according to claim 1, wherein the pull-up control module comprises:
a first control unit, comprising a first transistor, wherein a control terminal of the first transistor is configured to receive the pull-up control signal, an input terminal of the first transistor is electrically connected to the control terminal of the first transistor, and an output terminal of the first transistor is electrically connected to the first node; and
a second control unit, comprising a second transistor, wherein a control terminal of the second transistor is configured to receive the pull-up control signal, an input terminal of the second transistor is electrically connected to the first voltage terminal, and an output terminal of the second transistor is electrically connected to the second node.

3. The gate driving circuit according to claim 2, wherein the inverting module comprises:
a third transistor, wherein a control terminal of the third transistor is electrically connected to the low-frequency clock signal terminal, an input terminal of the third transistor is electrically connected to the control terminal of the third transistor, and an output terminal of the third transistor is electrically connected to the second node;
a fourth transistor, wherein a control terminal of the fourth transistor is electrically connected to the second node, an input terminal of the fourth transistor is electrically connected to the low-frequency clock signal terminal, and an output terminal of the fourth transistor is electrically connected to the third node;
a fifth transistor, wherein a control terminal of the fifth transistor is electrically connected to the first node, an input terminal of the fifth transistor is electrically connected to the first voltage terminal, and an output terminal of the fifth transistor is electrically connected to the second node; and
a sixth transistor, wherein a control terminal of the sixth transistor is electrically connected to the first node, an input terminal of the sixth transistor is electrically connected to the first voltage terminal, and an output terminal of the sixth transistor is electrically connected to the third node.

4. The gate driving circuit according to claim 3, wherein the pull-down holding module comprises:
a seventh transistor, wherein a control terminal of the seventh transistor is electrically connected to the third node, an input terminal of the seventh transistor is electrically connected to the first voltage terminal, and an output terminal of the seventh transistor is electrically connected to the first node.

5. The gate driving circuit according to claim 4, wherein the pull-up control module further comprises:
a third control unit, comprising an eighth transistor, wherein a control terminal of the eighth transistor is configured to receive the pull-up control signal, an input terminal of the eighth transistor is electrically connected to the first voltage terminal, and an output terminal of the eighth transistor is electrically connected to the third node.

6. The gate driving circuit according to claim 5,
wherein the second node comprises a first sub-node and a second sub-node, and the third node comprises a third sub-node and a fourth sub-node;
the low-frequency clock signal terminal comprises a first low-frequency clock signal terminal and a second low-frequency clock signal terminal;
the inverting module comprises a first inverting unit and a second inverting unit; in the first inverting unit, the output terminal of the third transistor, the control terminal of the fourth transistor, and the output terminal of the fifth transistor are electrically connected to the first sub-node, the output terminal of the fourth transistor and the output terminal of the sixth transistor are electrically connected to the third sub-node, and the control terminal of the third transistor and the input terminal of the fourth transistor are electrically connected to the first low-frequency clock signal terminal; and in the second inverting unit, the output terminal of the third transistor, the control terminal of the fourth transistor, and the output terminal of the fifth transistor are electrically connected to the second sub-node, the output terminal of the fourth transistor and the output terminal of the sixth transistor are electrically connected to the fourth sub-node, and the control terminal of the third transistor and the input terminal of the fourth transistor are electrically connected to the second low-frequency clock signal terminal;
the pull-down holding module comprises a first pull-down holding unit and a second pull-down holding unit, the control terminal of the seventh transistor of the first pull-down holding unit is electrically connected to the third sub-node, and the control terminal of the seventh transistor of the second pull-down holding unit is electrically connected to the fourth sub-node;
the second control unit of the pull-up control module comprises a first control sub-unit and a second control sub-unit, the output terminal of the second transistor of the first control sub-unit is electrically connected to the first sub-node, and the output terminal of the second transistor of the second control sub-unit is electrically connected to the second sub-node; and
the third control unit of the pull-up control module comprises a third control sub-unit and a fourth control sub-unit, the output terminal of the eighth transistor of the third control sub-unit is electrically connected to the third sub-node, and the output terminal of the eighth transistor of the fourth control sub-unit is electrically connected to the fourth sub-node.

7. The gate driving circuit according to claim 1, wherein the pull-down holding module comprises a ninth transistor, a control terminal of the ninth transistor is electrically connected to the third node, an input terminal of the ninth transistor is electrically connected to the first voltage terminal, and an output terminal of the ninth transistor is electrically connected to a signal output terminal of the gate driving circuit.

8. The gate driving circuit according to claim 1, further comprising:
an output module, comprising an output transistor and a first capacitor, wherein a control terminal of the output transistor is electrically connected to the first node, an input terminal of the output transistor is electrically connected to a high-frequency clock signal terminal, and an output terminal of the output transistor is electrically connected to a signal output terminal of the gate driving circuit, and the first capacitor is in series between the first node and the signal output terminal;
a pull-down control module, comprising a first pull-down transistor, wherein a control terminal of the first pull-down transistor is configured to receive a pull-down control signal, an input terminal of the first pull-down transistor is electrically connected to the first voltage terminal, and an output terminal of the first pull-down transistor is electrically connected to the first node; and
a reset module, comprising a first reset transistor and a second reset transistor, wherein a control terminal of the first reset transistor and a control terminal of the second reset transistor are configured to receive a reset control signal, an input terminal of the first reset transistor and an input terminal of the second reset transistor are electrically connected to the first voltage terminal, an output terminal of the first reset transistor is electrically connected to the first node, and an output terminal of the second reset transistor is electrically connected to a signal output terminal of the gate driving circuit.

9. The gate driving circuit according to claim 8, wherein the pull-down control module comprises a second pull-down transistor, a control terminal of the second pull-down transistor is configured to receive the pull-down control signal, an input terminal of the second pull-down transistor is electrically connected to the first voltage terminal, and an output terminal of the second pull-down transistor is electrically connected to the signal output terminal.

10. The gate driving circuit according to claim 8, further comprising:
a cascade transmission module, comprising a cascade transistor, wherein a control terminal of the cascade transistor is electrically connected to the first node, an input terminal of the cascade transistor is electrically connected to the high-frequency clock signal terminal, and an output terminal of the cascade transistor is electrically connected to a cascade transmission output terminal of the gate driving circuit.

11. The gate driving circuit according to claim 10, wherein the pull-down holding module further comprises a tenth transistor, a control terminal of the tenth transistor is electrically connected to the third node, an input terminal of the tenth transistor is electrically connected to the first voltage terminal, and an output terminal of the tenth transistor is electrically connected to the cascade transmission output terminal.

12. The gate driving circuit according to claim 10, wherein the reset module further comprises a third reset transistor, a control terminal of the third reset transistor is configured to receive the reset control signal, an input terminal of the third reset transistor is electrically connected to the first voltage terminal, and an output terminal of the third reset transistor is electrically connected to the cascade transmission output terminal.

13. A display panel, comprising a gate driving unit, the gate driving unit comprising a plurality of gate driving circuits arranged in cascade, and at least one of the gate driving circuits comprising:
an inverting module, electrically connected to a first voltage terminal, a first node, a second node, and a third node, configured to control a signal transmission between the first voltage terminal and the third node in response to a potential of the first node, and configured to control a signal transmission between a low-frequency clock signal terminal and the third node in response to a potential of the second node;
a pull-down holding module, electrically connected to the first voltage terminal, the first node, and the third node, and configured to control a signal transmission between the first voltage terminal and the first node in response to a potential of the third node; and
a pull-up control module, electrically connected to the first voltage terminal, the first node, and the second node, configured to pull up the potential of the first node in response to a pull-up control signal, and configured to control a signal transmission between the first voltage terminal and the second node in response to the pull-up control signal,
wherein when the pull-up control module is configured to electrically connect the first voltage terminal and the second node in response to the pull-up control signal, the inverting module is configured to disconnect an electrical connection between the low-frequency clock signal terminal and the third node in response to the potential of the second node, the inverting module is also configured to control an electrical connection between the first voltage terminal and the third node in response to the potential of the first node, and the pull-down holding module is configured to disconnect an electrical connection between the first voltage terminal and the first node in response to the potential of the third node; and
wherein an (n−4)th stage gate control signal output by an (n−4)th stage gate driving circuit serves as the pull-up control signal received by the pull-up control module of the n-th stage gate driving circuit.

14. The display panel according to claim 13, wherein a voltage of a low-frequency clock signal transmitted by the low-frequency clock signal terminal during a sensing phase of the display panel is less than a voltage of the low-frequency clock signal during a display phase of the display panel.

15. The display panel according to claim 13, comprising a plurality of sub-pixels electrically connected to the gate driving unit.

16. The display panel according to claim 13, wherein the pull-up control module comprises:
a first transistor, wherein a control terminal of the first transistor is configured to receive the pull-up control signal, an input terminal of the first transistor is electrically connected to the control terminal of the first transistor, and an output terminal of the first transistor is electrically connected to the first node; and
a second transistor, wherein a control terminal of the second transistor is configured to receive the pull-up control signal, an input terminal of the second transistor is electrically connected to the first voltage terminal, and an output terminal of the second transistor is electrically connected to the second node.

17. The display panel according to claim 16, wherein the inverting module comprises:
a third transistor, wherein a control terminal of the third transistor is electrically connected to the low-frequency clock signal terminal, an input terminal of the third transistor is electrically connected to the control terminal of the third transistor, and an output terminal of the third transistor is electrically connected to the second node;
a fourth transistor, wherein a control terminal of the fourth transistor is electrically connected to the second node, an input terminal of the fourth transistor is electrically connected to the low-frequency clock signal terminal, and an output terminal of the fourth transistor is electrically connected to the third node;
a fifth transistor, wherein a control terminal of the fifth transistor is electrically connected to the first node, an input terminal of the fifth transistor is electrically connected to the first voltage terminal, and an output terminal of the fifth transistor is electrically connected to the second node; and
a sixth transistor, wherein a control terminal of the sixth transistor is electrically connected to the first node, an input terminal of the sixth transistor is electrically connected to the first voltage terminal, and an output terminal of the sixth transistor is electrically connected to the third node.

18. The display panel according to claim 17, wherein the pull-down holding module comprises:
a seventh transistor, wherein a control terminal of the seventh transistor is electrically connected to the third node, an input terminal of the seventh transistor is electrically connected to the first voltage terminal, and an output terminal of the seventh transistor is electrically connected to the first node.

19. The display panel according to claim 18, wherein the pull-up control module further comprises:
an eighth transistor, wherein a control terminal of the eighth transistor is configured to receive the pull-up control signal, an input terminal of the eighth transistor is electrically connected to the first voltage terminal, and an output terminal of the eighth transistor is electrically connected to the third node.

20. The display panel according to claim 13, wherein the at least one of the gate driving circuits further comprises:
an output module, comprising an output transistor and a first capacitor, wherein a control terminal of the output transistor is electrically connected to the first node, an input terminal of the output transistor is electrically connected to a high-frequency clock signal terminal, and an output terminal of the output transistor is electrically connected to a signal output terminal of the gate driving circuit, and the first capacitor is in series between the first node and the signal output terminal;
a pull-down control module, comprising a first pull-down transistor, wherein a control terminal of the first pull-down transistor is configured to receive a pull-down control signal, an input terminal of the first pull-down transistor is electrically connected to the first voltage terminal, and an output terminal of the first pull-down transistor is electrically connected to the first node; and
a reset module, comprising a first reset transistor and a second reset transistor, wherein a control terminal of the first reset transistor and a control terminal of the second reset transistor are configured to receive a reset control signal, an input terminal of the first reset transistor and an input terminal of the second reset transistor are electrically connected to the first voltage terminal, an output terminal of the first reset transistor is electrically connected to the first node, and an output terminal of the second reset transistor is electrically connected to a signal output terminal of the gate driving circuit.
